(19) United States
(12) Patent Application Publication
(10) Pub. No.: US 2025/0240697 A1
(43) Pub. Date: Jul. 24, 2025

(54) MULTI-ORBIT INTEGRATED ACCESS AND BACKHAUL SYSTEM ARCHITECTURE

(71) Applicant: INTELSAT US LLC, McLean, VA (US)

(72) Inventors: Lance HASSAN, Leesburg, VA (US); Liang LI, Germantown, MD (US)

(73) Assignee: INTELSAT US LLC, McLean, VA (US)

(21) Appl. No.: 19/028,601

(22) Filed: Jan. 17, 2025

Related U.S. Application Data
(60) Provisional application No. 63/622,299, filed on Jan. 18, 2024.

(51) Int. Cl. H04W 40/02; H04W 88/08; H04W 88/16

(52) U.S. Cl. CPC H04W 40/02; H04W 88/085; H04W 88/16

(57) ABSTRACT

A method of providing integrated access and backhaul service for a communication network, including: receiving, by a terminal device, backhaul data from a mobile terminal associated with the communication network; selecting, by the terminal device, a backhaul link from among a plurality of backhaul links, wherein the plurality of backhaul links comprise a first backhaul link associated with a first satellite orbit, and a second backhaul link associated with a second satellite orbit; and transmitting, by the terminal device, the backhaul data to a gateway device associated with the communication network using the selected backhaul link.

### CROSS-REFERENCE TO RELATED APPLICATION(S)

This application is based on and claims priority under 35 U.S.C. § 119 to U.S. Provisional Patent Application No. 63/622,299, filed on Jan. 18, 2024, in the U.S. Patent & Trademark Office, the disclosure of which is incorporated by reference herein in its entirety.

### BACKGROUND

### 1. Field

The disclosure relates to satellite communication, and more particularly to providing multi-orbit integrated access and backhaul (IAB) for a communication network.

### 2. Description of Related Art

To enable mobility for satellite communication terminals operating on various satellite communication platforms, vendor-proprietary solutions are often deployed. However, these solutions are usually not capable of interoperation. Given the proprietary nature of these satellite communication platforms, separate overlapping networks may be required to facilitate global mobility for terminals connected to each of these platforms, which may be very expensive to deploy, operate, and maintain.

Other approaches may use software-defined wide area network (SD-WAN) to aggregate user data from a satellite communication terminal, for example using modems for multiple disparate orbits. However, these approaches remain non-standard, and are often not interoperable between different satellite communication platforms.

Network technologies such as 3rd Generation Partnership Project (3GPP) fifth generation (5G) networks may provide robust interoperability, but also may have limitations in other areas. For example, 5G networks may allow the use of integrated access and backhaul (IAB), which may allow one node to provide wireless backhaul service for another node, such as a mobile node for traditional backhaul is not available. However, 5G IAB is currently limited to a one-to-one association between nodes, and it is therefore difficult to simultaneously provide backhaul service using multiple different links, for example satellite links using multiple disparate orbits.

Accordingly, there is a need for a network implementation that provides the flexibility to use different networks, for example multiple satellite links using different orbits, while maintaining 5G interoperability.

### SUMMARY

Example embodiments address at least the above problems and/or disadvantages and other disadvantages not described above. Also, the example embodiments are not required to overcome the disadvantages described above, and may not overcome any of the problems described above.

In accordance with an aspect of the disclosure, a method of providing a backhaul connection for a communication network includes: receiving, by a terminal device, backhaul data from a mobile terminal (MT) associated with the communication network; selecting, by the terminal device, a backhaul link from among a plurality of backhaul links, wherein the plurality of backhaul links comprise a first backhaul link associated with a first satellite orbit, and a second backhaul link associated with a second satellite orbit; and transmitting, by the terminal device, the backhaul data to a gateway device associated with the communication network using the selected backhaul link.

In accordance with an aspect of the disclosure, a terminal device for providing a backhaul connection for a communication network includes: at least one processor; and a memory configured to store instructions which, when executed by the at least one processor, cause the at least one processor to: receive backhaul data from a mobile terminal (MT) associated with the communication network, select a backhaul link from among a plurality of backhaul links, wherein the plurality of backhaul links comprise a first backhaul link associated with a first satellite orbit, and a second backhaul link associated with a second satellite orbit, and transmit the backhaul data to a gateway device associated with the communication network using the selected backhaul link.

In accordance with an aspect of the disclosure, a gateway device for providing a backhaul connection for a communication network includes: at least one processor; and a memory configured to store instructions which, when executed by the at least one processor, cause the at least one processor to: receive backhaul data from a terminal device associated with the communication network using a backhaul link from among a plurality of backhaul links, wherein the plurality of backhaul links comprise a first backhaul link associated with a first satellite orbit, and a second backhaul link associated with a second satellite orbit, and transmit the backhaul data to a core network associated with the communication network.

### BRIEF DESCRIPTION OF THE DRAWINGS

The above and other aspects, features, and aspects of embodiments of the disclosure will be more apparent from the following description taken in conjunction with the accompanying drawings, in which:

FIG. 1 is a block diagram illustrating an example of a network including integrated access and backhaul (IAB), according to embodiments.

FIG. 2 is a block diagram illustrating examples of detailed configurations of devices included in a network including IAB, according to embodiments.

FIG. 3 is a block diagram illustrating an example of a network including IAB using non-terrestrial networks (NTN), according to embodiments.

FIG. 4 is a block diagram illustrating an example of a multi-orbit satellite communication network including IAB, according to embodiments.

FIGS. 5A and 5B are a flowcharts illustrating processes for providing a backhaul connection for a communication network, according to embodiments.

FIG. 6 is a block diagram of an electronic device in a network environment 600, according to an embodiment.

FIG. 7 shows a system including a user equipment and a base station in communication with each other, according to an embodiment.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

While such terms as “first,” “second,” etc., may be used to describe various elements, such elements must not be limited to the above terms. The above terms may be used only to distinguish one element from another.

The term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

Embodiments may relate to a multi-orbit satellite communication terminal which utilizes multiple 5G integrated access and backhaul (IAB) networks with over-the-air connections provided in parallel by low Earth orbit (LEO), a medium Earth orbit (MEO), a geostationary Earth orbit (GEO), high-altitude platform station (HAPS), cellular, and other access networks that may provide connectivity to remote terminals used for satellite communications. For example, embodiments may allow parallel 5G IAB networks to be combined using a trunking solution to bond these disparate access networks together, which may provide multi-link IAB service (e.g., multi-orbit 5G IAB service).

Embodiments of the present disclosure may address a problem with some 5G IAB implementations. For example, 5G IAB may allow a first node in a 5G network to receive backhaul service through a second node in situations in which traditional backhaul is not available. According to embodiments, the first node may be referred to as an IAB-node, while the second node may be referred to as an IAB-donor, and the first node and the second node together may act as a base station such as a 5G gNodeB (gNB). The one-to-one association between IAB-donor and IAB-node may be a limitation of the 5G IAB reference architecture, because it may not allow for multiple different backhaul technologies to be used in parallel, as may be needed for multi-orbit satellite communication applications with mobile IAB node terminals.

Embodiments may leverage 5G non-terrestrial networks (NTNs) to enable terminal and platform interoperability using industry standards to reduce system costs with the economy of scale driven by terrestrial mobile network operators (MNOs). This may enable devices operating based on 5G standards to support vendor interoperability between mobile satellite communication terminals and the platforms that provide service to these terminals, allowing a single, unified network to be deployed, operated, and maintained globally.

Multi-orbit 5G satellite access according to embodiments may provide benefits such as enhanced throughput, improved compressibility, and increased or optimized Quality of Service (QoS) for mobility implementations, for example maritime, aero, land mobility and government vessels. In addition, embodiments may also provide these and other benefits for fixed terminals, such as cellular communications for small cell access to mobile devices.

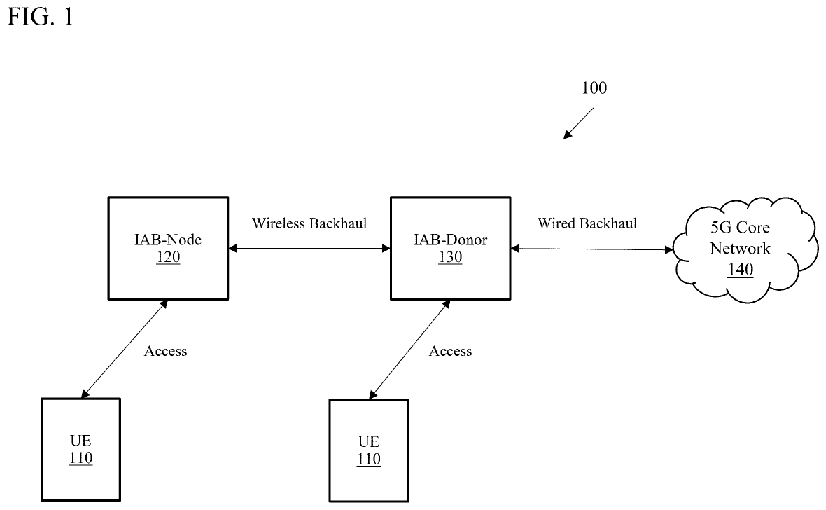

FIG. 1 is a block diagram illustrating an example of a network including IAB, according to embodiments. As shown in FIG. 1, the network 100 may include at least one UE 110, an IAB-node 120, an IAB-donor 130, and a 5G core network 140.

As shown in FIG. 1, the at least one UE 110 may receive 5G network access from an IAB-node 120 or an IAB-donor 130. When a UE 110 is connected to the IAB-donor 130, communication from the UE 110 may reach the 5G core network using wired backhaul (e.g. optical fiber) that is connected to IAB-donor 130. However, if the UE 110 is connected to the IAB-node 120, the communication may be relayed by the IAB-node 120 to the IAB-donor 130 using wireless backhaul, and may then reach the 5G core network 140 using the wired backhaul.

Accordingly, the IAB-node 120 may act as a relay cell which may be wirelessly connected to the IAB-donor 130. Therefore, the IAB-node 120 and the IAB-donor 130 may operate together as a base station such as a 5G gNB, but embodiments are not limited thereto. According to embodiments, IAB may be implemented using at least on of in-band IAB, in which access and backhaul use the same frequency, and out-of-band IAB, in which access and backhaul use different frequencies.

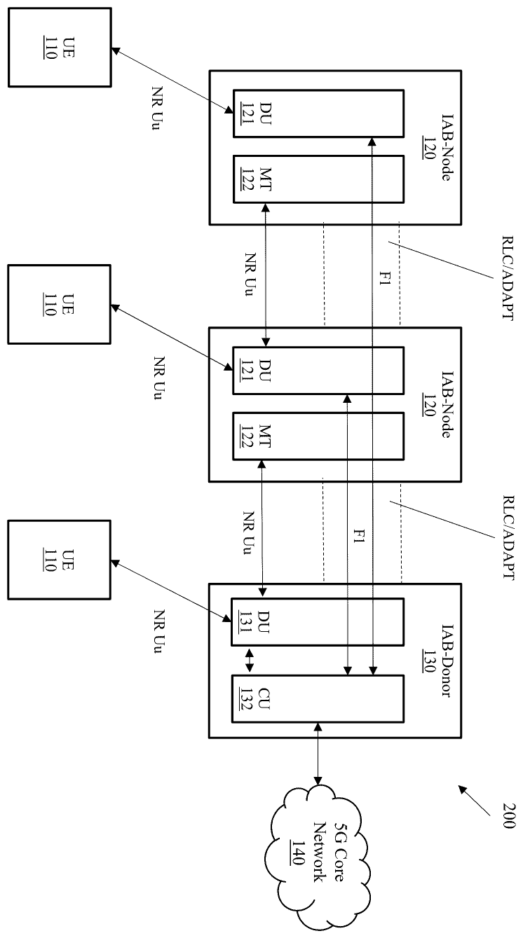

FIG. 2 is a block diagram illustrating examples of detailed configurations of devices included in a network including IAB, according to embodiments. As shown in FIG. 2, the network 200 may include an IAB-donor 130 and two IAB-nodes 120.

According to embodiments, each of the IAB-nodes 120 may include a distributed unit (DU) 121 and a mobile terminal (MT) 122. As shown in FIG. 2, the IAB wireless backhaul may operate using a single hop or multiple hops. For example, the MT 121 included in each of the IAB-nodes 120 may be used to communicate with a parent node (e.g., the IAB-donor 130 or another IAB-node 120), and the DU 121 included in each of the IAB-nodes 120 may be used to communicate with a child node (e.g., another IAB-node 120) or a UE 110. According to embodiments, the IAB-nodes 120 may be mobile, but a mobile IAB-Node may not serve as an IAB-donor. Each IAB-node 120 may contain multiple DUs 121, but each DU 121 may be connected with only one CU 132.

The IAB-donor 130 may include a centralized unit (CU) 132 and a DU 131. The DU 131 may be used to support UEs 110 as well as the MTs 122 included in the IAB-nodes 120. According to embodiments, the DUs 131 may be served by only one IAB-donor 130, but this IAB-donor 130 may change through topology adaptation.

According to embodiments, the IAB-donor 130 and the IAB-nodes 120 may operate as a gNB. For example, the CU 132 may operate as, or be referred to as a, an IAB-donor gNB-CU, the DU 131 may operate as, or be referred to as, an IAB-donor gNB-DU, and the DUs 121 may operate as, or be referred to as, IAB-node gNB-DUs. In addition, the MTs 122 may be referred to as IAB-node MTs.

According to embodiments, the CU 132 may host, for example, radio resource control (RRC), service data adaptation protocol (SDAP) and packet data convergence protocol (PDCP) of the gNB. In addition, each of the DU 131 and the DUs 121 may host, for example, radio link control (RLC), medium access control (MAC) and physical (PHY) layers of the gNB.

The CU 132 may be connected to the DU 131 and the DUs 121 using an F1 interface, or using a modified F1 interface, which may be referred to as an F1* interface. The F1 interface (or F1* interface) may operate over RLC channels using the wireless backhaul between the MTs 122 and the DU 131. An adaptation layer may be added, which may hold routing information, enabling hop-by-hop forwarding. In addition, each of the DU 131 and the DUs 121 may provide access to the UEs 110, for example using a new radio (NR) Uu interface.

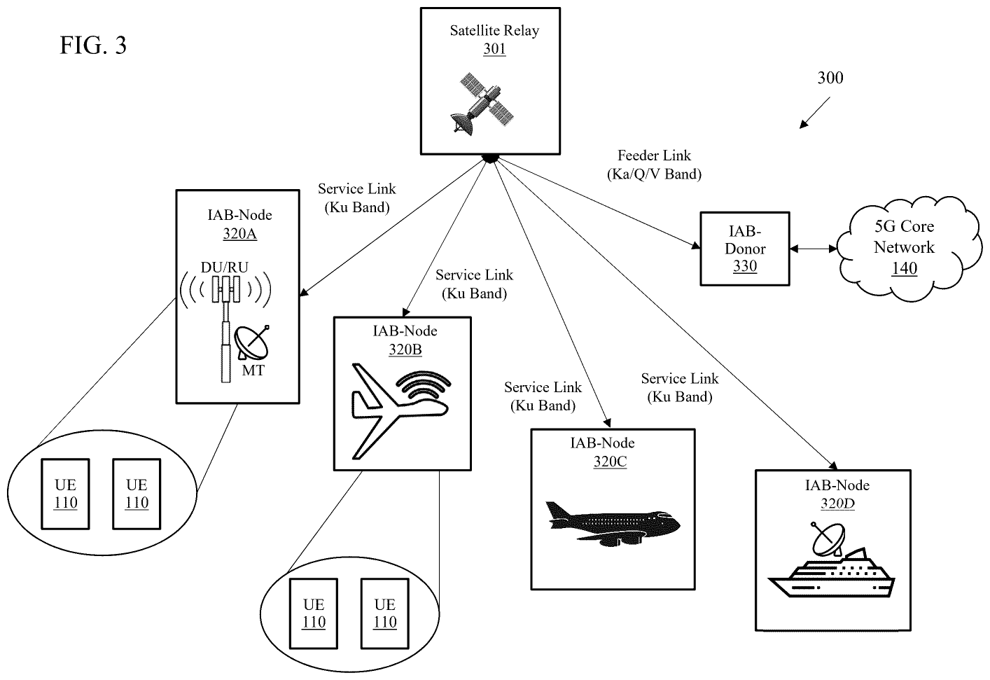

FIG. 3 is a block diagram illustrating an example of a network including IAB using non-terrestrial networks (NTN), according to embodiments. As shown in FIG. 3, the network 300 may include an IAB-donor 330, a satellite relay 301, and a plurality of IAB-nodes 320, for example an IAB-node 320A, which may be a terrestrial IAB-Node, an IAB-node 320B, which may be included for example in a HAPS such as a drone or balloon, and IAB-node 320C and IAB-node 320D, which may be included in vessels such as airplanes and ships.

According to embodiments, the IAB-donor 330 may be similar to the IAB-donor 130 discussed above, and the IAB-nodes 320 may be similar to the IAB-nodes 120 discussed above. For example, the IAB-donor 330 and the IAB-nodes 320 may operate as a gNB. However, unlike the IAB-donor 130 and the IAB-nodes 120, the IAB-donor 330 may be connected to the IAB-nodes 320 through a satellite link corresponding to the satellite relay 301. For example, satellite relay 301 may be included in a satellite which orbits in one of a LEO, a MEO, a GEO, or any other type of orbit. Accordingly, the satellite link may be one of a LEO satellite link, a MEO satellite link, GEO satellite link, or any other type of satellite link.

According to embodiments, the IAB-nodes 320 may communicate with the satellite relay 301 using a service link, which may be for example a Ku-band link, and the satellite relay 301 may communicate with the IAB-donor 330 using a feeder link, which may be for example at least one of a Ka-band link, a Q-band link, and a V-band link. The IAB-nodes 320 may provide access to the UEs 110 using at least one of citizens broadband radio service (CBRS), NR in unlicensed WiFi spectrum (NR-U), and licensed spectrum.

Accordingly, by providing IAB connections using the satellite relay 301, the network 300 may be expanded to include NTN networks provided by the IAB-nodes 320, or any other NTN network which may communicate with the satellite relay 301. In addition, UEs 110 such as handset devices of other MNOs may be served by the satellite relay 301 using roaming or multi operator core network (MOCN) connections. As a result, the network 300 may provide a standardized integrated solution for relatively fast deployment with relatively low cost in comparison with, for example, normal terrestrial deployments, and can provide access to UEs in remote areas that would be difficult to reach otherwise, or in dangerous situations such as disaster areas.

However, despite these benefits, the network 300 may still be limited by the requirement that each IAB-node 320 may be connected only to a single IAB-donor 300. As a result, it may not be possible for the network 300 to connect with other networks using multiple different satellite links, for example satellite links corresponding to multiple different orbits.

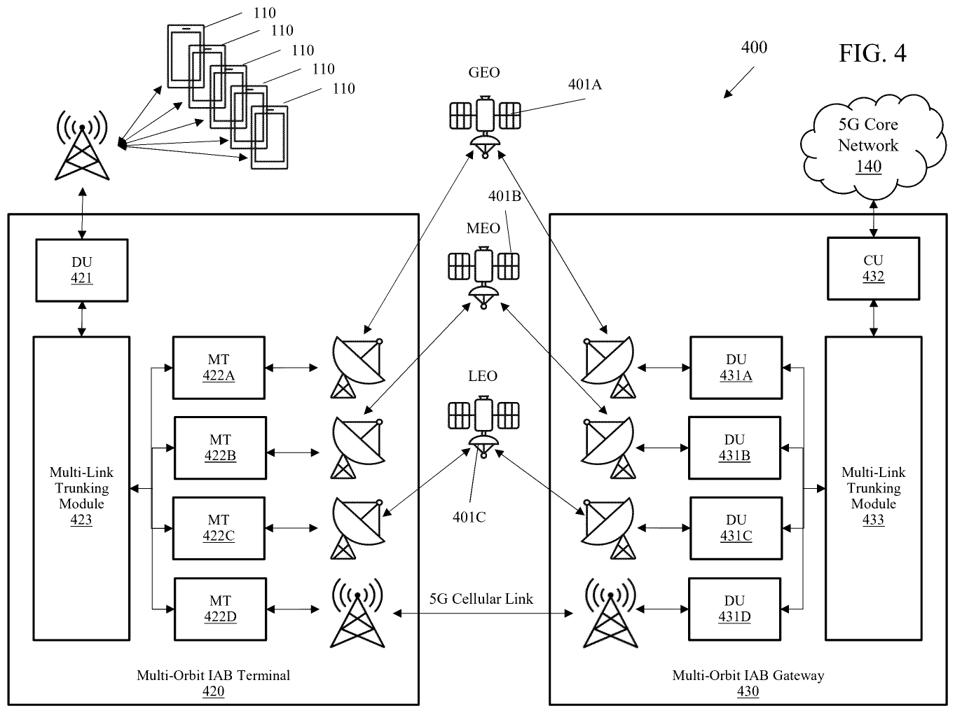

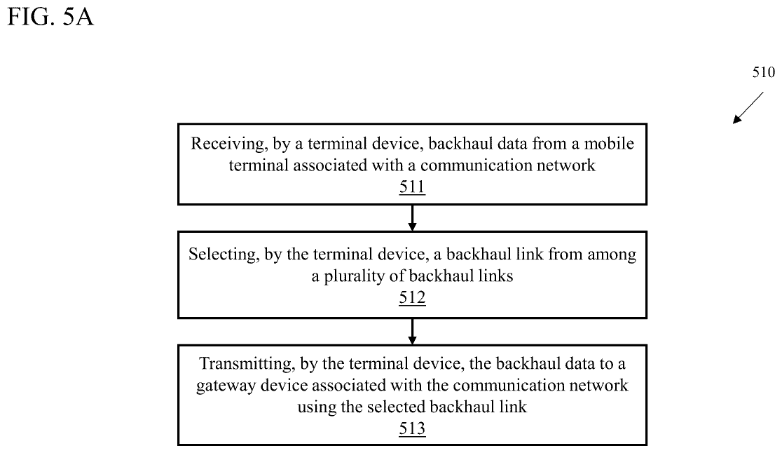

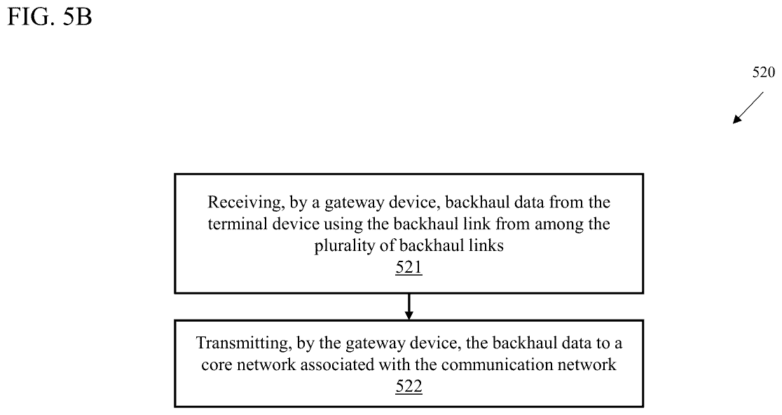

Accordingly, embodiments may provide a multi-orbit satellite communication system architecture (or, for example, a multi-link communication system architecture) which may provide some or all of the benefits of the network 300 discussed above, while also allowing multiple different links (e.g., multiple different satellite links) to be used. Examples of such a multi-orbit satellite communication system and network are described below with reference to FIGS. 4 and 5A-5B.

FIG. 4 is a block diagram illustrating an example of a multi-orbit satellite communication network including IAB, according to embodiments. As shown in FIG. 4, the network 400 may include a mult-orbit IAB terminal, a mult-orbit IAB gateway 430, and a plurality of satellite relays 401, which may include for example a satellite relay 401A, a satellite relay 401B, and a satellite relay 401C.

The multi-orbit IAB terminal 420 may include a DU 421 and a plurality of MTs 422, for example an MT 422A, an MT 422B, an MT 422C, and an MT 422D. The multi-orbit IAB terminal 420 may also include a multi-link trunking module 423, which may manage communication between the DU 421 and the plurality of MTs 422.

The multi-orbit IAB gateway 420 may include a DU 421 and a plurality of MTs 422, for example an MT 422A, an MT 422B, an MT 422C, and an MT 422D. The multi-orbit IAB terminal 420 may also include a multi-link trunking module 423, which may manage communication between the DU 421 and the plurality of MTs 422.

By using the multi-link trunking module 423 and the multi-link trunking module 433, the network 400 may provide IAB service using a plurality of different backhaul links. For example, the multi-orbit IAB terminal 420 and the multi-orbit IAB gateway 430 may communicate with each other using the plurality of satellite relays 401, which may correspond to a plurality of satellite links which may be used to provide backhaul connections.

According to embodiments, the plurality of satellite relays 401 may correspond to different orbits. For example, the satellite relay 401A may be included in a GEO satellite, and may communicate with the MT 422A and the DU 431A using a GEO satellite link. In addition, the satellite relay 401B may be included in a MEO satellite, and may communicate with the MT 422B and the DU 431B using a MEO satellite link. Further, the satellite relay 401C may be included in a LEO satellite, and may communicate with the MT 422C and the DU 431A using a LEO satellite link.

In addition to the plurality of satellite links, the plurality of backhaul links may also include other types of links, for example a terrestrial link such as a 5G cellular link, which may be accessed using the MT 422D and the DU 431D.

Each of the satellite relays 401 may be similar to the satellite relay 301. For example, each of the satellite relays 401 may communicate with a corresponding MT 422 using a service link such as a Ku-band link, and may communicate with a corresponding DU 431 using a feeder link such as at least one of a Ka-band link, a Q-band link, and a V-band link. In addition, the multi-link trunking module 423 may communicate with the DU 421 using an F1 interface (or a modified F1* interface), and the multi-link trunking module 433 may communicate with the CU 432 using an F1 interface (or a modified F1* interface).

According to embodiments, the multi-link trunking module 423 and the multi-link trunking module 433 may provide traffic optimization in order to increase throughput. For example, at least one of the multi-link trunking module 423 and the multi-link trunking module 433 may be implemented using a trunking device such as a XipLink platform or device, but embodiments are not limited thereto, and any other multi-link bonding technique or device may be used. Accordingly, by using such a trunking device, embodiments may provide benefits such as enhanced throughput, improved compressibility, and increased or optimized QoS.

According to embodiments, the multi-orbit IAB terminal 420 and the multi-orbit IAB gateway 430 may operate as a gNB which is implemented using IAB. For example, the CU 432 may operate as a IAB-donor gNB-CU, the DU 421 may operate as an IAB-node gNB-DU, and each of the plurality of DUs 431 may operate as an IAB-donor gNB-DU. In addition, each of the plurality of MTs 422 may operate as an IAB-node MT. For example, the MT 422A may be referred to as an IAB-Node GEO-MT, the MT 422B may be referred to as an IAB-Node MEO-MT, the MT 422C may be referred to as an IAB-Node LEO-MT, and the MT 422D may be referred to as an IAB-Node TN-MT.

Accordingly, the multi-orbit IAB terminal 420 and the multi-orbit IAB gateway 430 may provide the benefits of 5G IAB, and while also providing the flexibility of multiple simultaneous backhaul links, for example multiple satellite links which correspond to different orbits.

Although examples are described above in which the plurality of backhaul links correspond to multiple different satellite orbits, embodiments are not limited thereto. For example, in some embodiments, the plurality of backhaul links may correspond to multiple different terrestrial links, or multiple different links which are provided in a different manner. Accordingly, in some embodiments, the multi-orbit IAB terminal 420 may be referred to as a multi-link IAB terminal, and the multi-orbit IAB gateway 430 may be referred to as a multi-link IAB gateway.

FIG. 5A is a flowchart illustrating a process for providing a backhaul connection for a communication network, according to embodiments. In embodiments, the process 510 illustrated in FIG. 5A may be performed by any of the elements discussed above, for example at least one of the multi-orbit terminal 420, or any of the elements included therein.

At operation 511, the process 510 may include receiving, by a terminal device, backhaul data from an MT associated with the communication network. In embodiments, the terminal device may correspond to the multi-orbit IAB terminal 420 discussed above, the communication network may correspond to a 5G communication network, and the MT may correspond to any of the MTs discussed above, and may for example be included in any one from among the UE 110, the IAB-node 120, and the IAB-nodes 320 discussed above.

At operation 512, the process 510 may include selecting, by the terminal device, a backhaul link from among a plurality of backhaul links. In embodiments, the plurality of backhaul links may include a first backhaul link associated with a first satellite orbit, and a second backhaul link associated with a second satellite orbit. In embodiments, the backhaul link may be selected by or using the multi-link trunking module 423 discussed above.

At operation 513, the process 510 may include transmitting, by the terminal device, the backhaul data to a gateway device associated with the communication network using the selected backhaul link. In embodiments, the gateway device may correspond to the multi-orbit IAB gateway 430 discussed above. In embodiments, the backhaul data may be transmitted using the backhaul link through any one of the satellite relays 401 discussed above.

In embodiments, the plurality of backhaul links may further include a third backhaul link associated with a third satellite orbit, and the first satellite orbit, the second satellite orbit, and the third satellite orbit may include a low Earth orbit (LEO), a medium Earth orbit (MEO), and a geostationary Earth orbit (GEO).

In embodiments, the backhaul data may be transmitted by the gateway device to a core network associated with the communication network. In embodiments, the core network may be the 5G core network 140 discussed above.

In embodiments, the terminal device may include a plurality of node modules associated with the plurality of backhaul links, and a first trunking module configured to provide the backhaul data to a node module associated with the selected backhaul link from among the plurality of node modules. In embodiments, the plurality of node modules may correspond to the plurality of MTs 422 discussed above, and the first trunking module may correspond to the multi-link trunking module 423 discussed above.

In embodiments, the gateway device may include a plurality of donor modules associated with the plurality of backhaul links, and a second trunking module configured to receive the backhaul data from a donor module associated with the selected backhaul link from among the plurality of donor modules. In embodiments, the plurality of donor modules may correspond to the plurality of DUs 431 discussed above, and the second trunking module may correspond to the multi-link trunking module 433 discussed above.

In embodiments, the communication network may include a 5G cellular network, the MT may be included in at least one of a UE device and an IAB-node, the plurality of node modules may include a plurality of IAB-node MTs, and the plurality of donor modules may include a plurality of IAB-donor gNB-DUs.

n embodiments, the backhaul data may be received from the MT using an IAB-node gNB-DU included in the terminal device, and the backhaul data may be transmitted to a core network associated with the communication network using an IAB-donor gNB-CU included in the gateway device. In embodiments, the IAB-node gNB-DU may correspond to the DU 421 discussed above, and the IAB-donor gNB-CU may correspond to the CU 432 discussed above.

In embodiments, the backhaul data may be provided to the first trunking module by the IAB-node gNB-DU using a first F1 interface, and the backhaul data may be provided from the second trunking module to the IAB-donor gNB-CU using a second F1 interface.

In embodiments, the plurality of backhaul links may further include a 5G cellular backhaul link.

FIG. 5B is a flowchart of a process for providing a backhaul connection for a communication network. In embodiments, the process 520 illustrated in FIG. 5B may be performed by any of the elements discussed above, for example at least one of the multi-orbit gateway 430, or any of the elements included therein. In embodiments, one or more operations of the process 520 may be performed after or in combination or cooperation with one or more operations of the process 510 discussed above.

At operation 521, the process 520 may include receiving, by the gateway device, the backhaul data from the terminal device associated with the communication network using the backhaul link from among the plurality of backhaul links.

At operation 522, the process 520 may include transmitting the backhaul data to the core network associated with the communication network.

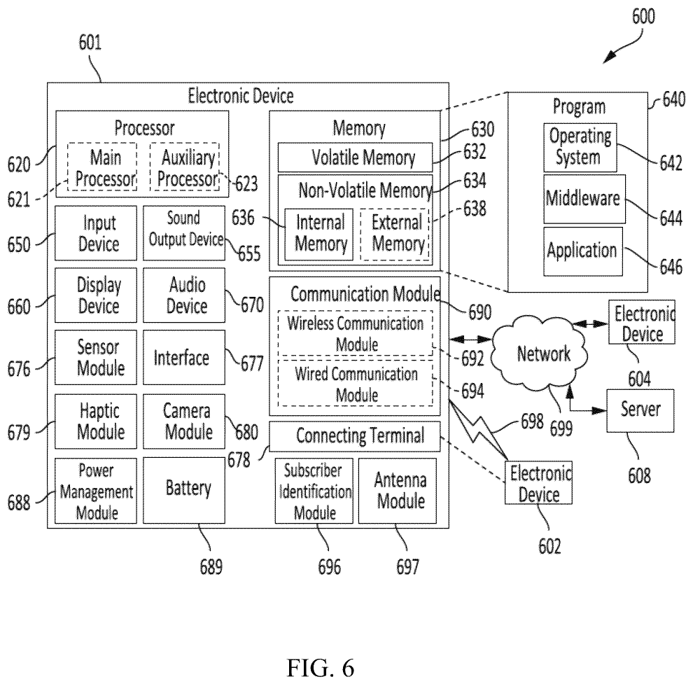

FIG. 6 is a block diagram of an electronic device in a network environment 600, according to an embodiment. According to embodiments, one or more of the elements illustrated in FIG. 6, or any of the components included in therein, may correspond to or may be included in any of the elements discussed above. For example, one or more of the elements illustrated in FIG. 6 may be included in at least one of the UE 110, the IAB-node 120, the IAB-donor 120, the satellite relay 301, the IAB-nodes 320, the IAB-donor 330, the satellite relays 401, the multi-orbit IAB terminal 420, the multi-orbit IAB gateway 430, or any other element discussed above.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations. For example, in some embodiments one or more operations of processes 510 and 520 may be performed by the processor 620 based on instructions stored in the memory 630.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC). In embodiments, the input video may be captured by the camera module 680, but embodiments are not limited thereto.

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™M, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

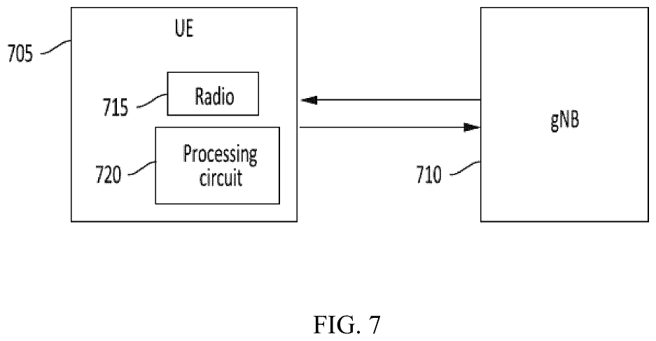

FIG. 7 shows a system including a UE 705 and a gNB 710, in communication with each other. The UE may include a radio 715 and a processing circuit (or a means for processing) 720, which may perform various methods disclosed herein, e.g., the method illustrated in FIG. 1. For example, the processing circuit 720 may receive, via the radio 715, transmissions from the network node (gNB) 710, and the processing circuit 720 may transmit, via the radio 715, signals to the gNB 710.

The foregoing disclosure provides illustration and description, but is not intended to be exhaustive or to limit the implementation to the precise form disclosed. Modifications and variations are possible in light of the above disclosure or may be acquired from practice of the implementation.

As used herein, the term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

The embodiments of the disclosure described above may be written as computer executable programs or instructions that may be stored in a medium.

The medium may continuously store the computer-executable programs or instructions, or temporarily store the computer-executable programs or instructions for execution or downloading. Also, the medium may be any one of various recording media or storage media in which a single piece or plurality of pieces of hardware are combined, and the medium is not limited to a medium directly connected to a particular electronic device, but may be distributed on a network. Examples of the medium include magnetic media, such as a hard disk, a floppy disk, and a magnetic tape, optical recording media, such as CD-ROM and DVD, magneto-optical media such as a floptical disk, and ROM, RAM, and a flash memory, which are configured to store program instructions. Other examples of the medium include recording media and storage media managed by application stores distributing applications or by websites, servers, and the like supplying or distributing other various types of software.

The methods and processes described above may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated.

While some embodiments of the disclosure are described above with reference to the figures, it will be understood by those of ordinary skill in the art that various changes in form and details may be made therein without departing from the spirit and scope as defined by the following claims.

What is claimed is:

1. A method of providing a backhaul connection for a communication network, the method comprising:
receiving, by a terminal device, backhaul data from a mobile terminal (MT) associated with the communication network;
selecting, by the terminal device, a backhaul link from among a plurality of backhaul links, wherein the plurality of backhaul links comprise a first backhaul link associated with a first satellite orbit, and a second backhaul link associated with a second satellite orbit; and
transmitting, by the terminal device, the backhaul data to a gateway device associated with the communication network using the selected backhaul link.

2. The method of claim 1, wherein the plurality of backhaul links further comprise a third backhaul link associated with a third satellite orbit,
wherein the first satellite orbit, the second satellite orbit, and the third satellite orbit comprise a low Earth orbit (LEO), a medium Earth orbit (MEO), and a geostationary Earth orbit (GEO).

3. The method of claim 1, wherein the backhaul data is transmitted by the gateway device to a core network associated with the communication network.

4. The method of claim 1, wherein the terminal device comprises a plurality of node modules associated with the plurality of backhaul links, and a first trunking module configured to provide the backhaul data to a node module associated with the selected backhaul link from among the plurality of node modules, and
wherein the gateway device comprises a plurality of donor modules associated with the plurality of backhaul links, and a second trunking module configured to receive the backhaul data from a donor module associated with the selected backhaul link from among the plurality of donor modules.

5. The method of claim 4, wherein the communication network comprises a fifth generation (5G) cellular network,
wherein the MT is included in at least one of a user equipment (UE) device and integrated access and backhaul (IAB)-node,
wherein the plurality of node modules comprise a plurality of IAB-node MTs, and
wherein the plurality of donor modules comprise a plurality of IAB-donor gNodeB (gNB)-distributed units (DUs).

6. The method of claim 5, wherein the backhaul data is received from the MT using an IAB-node gNB-DU included in the terminal device, and
wherein the backhaul data is transmitted to a core network associated with the communication network using an IAB-donor gNB-centralized unit (CU) included in the gateway device.

7. The method of claim 6, wherein the backhaul data is provided to the first trunking module by the IAB-node gNB-DU using a first F1 interface, and
wherein the backhaul data is provided from the second trunking module to the IAB-donor gNB-CU using a second F1 interface.

8. The method of claim 5, wherein the plurality of backhaul links further comprise a 5G cellular backhaul link.

9. A terminal device for providing a backhaul connection for a communication network, the terminal device comprising:
at least one processor; and
a memory configured to store instructions which, when executed by the at least one processor, cause the at least one processor to:
receive backhaul data from a mobile terminal (MT) associated with the communication network,
select a backhaul link from among a plurality of backhaul links, wherein the plurality of backhaul links comprise a first backhaul link associated with a first satellite orbit, and a second backhaul link associated with a second satellite orbit, and
transmit the backhaul data to a gateway device associated with the communication network using the selected backhaul link.

10. The terminal device of claim 9, wherein the plurality of backhaul links further comprise a third backhaul link associated with a third satellite orbit,
wherein the first satellite orbit, the second satellite orbit, and the third satellite orbit comprise a low earth orbit (LEO), a medium earth orbit (MEO), and a geostationary earth orbit (GEO).

11. The terminal device of claim 9, wherein the backhaul data is transmitted by the gateway device to a core network associated with the communication network.

12. The terminal device of claim 9, wherein the terminal device further comprises a plurality of node modules associated with the plurality of backhaul links, and a first trunking module configured to provide the backhaul data to a node module associated with the selected backhaul link from among the plurality of node modules, and
wherein the gateway device comprises a plurality of donor modules associated with the plurality of backhaul links, and a second trunking module configured to receive the backhaul data from a donor module associated with the selected backhaul link from among the plurality of donor modules.

13. The terminal device of claim 12, wherein the communication network comprises a fifth generation (5G) cellular network,
wherein the MT is included in at least one of a user equipment (UE) device and integrated access and backhaul (IAB)-node,
wherein the plurality of node modules comprise a plurality of IAB-node MTs, and
wherein the plurality of donor modules comprise a plurality of IAB-donor gNodeB (gNB) distributed units (DUs).

14. The terminal device of claim 13, further comprising an IAB-node gNB-DU configured to receive the backhaul data from the MT,
wherein the backhaul data is transmitted to a core network associated with the communication network using an IAB-donor gNB-centralized unit (CU) included in the gateway device.

15. The terminal device of claim 14, wherein the backhaul data is provided to the first trunking module by the IAB-node gNB-DU using a first F1 interface, and
wherein the backhaul data is provided from the second trunking module to the IAB-donor gNB-CU using a second F1 interface.

16. The terminal device of claim 13, wherein the plurality of backhaul links further comprise a 5G cellular backhaul link.

17. A gateway device for providing a backhaul connection for a communication network, the gateway device comprising:
at least one processor; and
a memory configured to store instructions which, when executed by the at least one processor, cause the at least one processor to:
receive backhaul data from a terminal device associated with the communication network using a backhaul link from among a plurality of backhaul links, wherein the plurality of backhaul links comprise a first backhaul link associated with a first satellite orbit, and a second backhaul link associated with a second satellite orbit, and
transmit the backhaul data to a core network associated with the communication network.

18. The gateway device of claim 17, wherein the plurality of backhaul links further comprise a third backhaul link associated with a third satellite orbit,
wherein the first satellite orbit, the second satellite orbit, and the third satellite orbit comprise a low Earth orbit (LEO), a medium Earth orbit (MEO), and a geostationary Earth orbit (GEO).

19. The gateway device of claim 17, wherein the terminal device comprises a plurality of node modules associated with the plurality of backhaul links, and a first trunking module configured to provide the backhaul data to a node module associated with the selected backhaul link from among the plurality of node modules, and
wherein the gateway device further comprises a plurality of donor modules associated with the plurality of backhaul links, and a second trunking module configured to receive the backhaul data from a donor module associated with the selected backhaul link from among the plurality of donor modules.

20. The gateway device of claim 19, wherein the communication network comprises a fifth generation (5G) cellular network,
wherein the backhaul data is received by the terminal device from a mobile terminal (MT) associated with the communication network,
wherein the MT is included in at least one of a user equipment (UE) device and integrated access and backhaul (IAB)-node,
wherein the plurality of node modules comprise a plurality of IAB-node MTs, and
wherein the plurality of donor modules comprise a plurality of IAB-donor gNodeB (gNB)-distributed units (DUs), and
wherein the plurality of backhaul links further comprise a 5G cellular backhaul link.
